(19) United States
(12) Patent Application Publication
(10) Pub. No.: US 2011/0119590 A1
(43) Pub. Date: May 19, 2011

(54) SYSTEM AND METHOD FOR PROVIDING A SPEECH CONTROLLED PERSONAL ELECTRONIC BOOK SYSTEM

(76) Inventor: Nambirajan Seshadri, Irvine, CA (US)

(21) Appl. No.: 12/948,278

(22) Filed: Nov. 17, 2010

Related U.S. Application Data
(60) Provisional application No. 61/262,310, filed on Nov. 18, 2009.

(51) Int. Cl. G06F 3/16

(52) U.S. Cl. 715/728

(57) ABSTRACT

A system and method in a personal electronic book system for providing speech-controlled operation thereof. As non-limiting examples, an electronic book reader may comprise one or more modules operable to utilize a default set of speech commands and/or develop a suite of customized speech commands to be utilized for controlling operation of the electronic book reader.

### CROSS-REFERENCE TO RELATED APPLICATIONS/INCORPORATION BY REFERENCE

This patent application is related to and claims priority from provisional patent application Ser. No. 61/262,310 filed Nov. 18, 2009, and titled “SYSTEM AND METHOD FOR PROVIDING A SPEECH CONTROLLED PERSONAL ELECTRONIC BOOK SYSTEM,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

In various operational scenarios, present control mechanisms for personal electronic book systems are inadequate.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method in a personal electronic book system for providing speech-controlled operation thereof.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a block diagram of a non-limiting exemplary personal electronic book system, in accordance with various aspects of the present invention.

FIG. 2 is an illustration of various personal electronic book operating environments, in accordance with various aspects of the present invention.

FIG. 3 is an illustration of various personal electronic book operating environments, in accordance with various aspects of the present invention.

FIG. 4 is a block diagram of a non-limiting exemplary personal electronic book system, in accordance with various aspects of the present invention.

FIG. 5 is a flow diagram illustrating a non-limiting exemplary method for operating a personal electronic book system, in accordance with various aspects of the present invention.

FIG. 6 is a flow diagram illustrating a non-limiting exemplary method for operating a personal electronic book system, in accordance with various aspects of the present invention.

### DETAILED DESCRIPTION OF VARIOUS NON-LIMITING ASPECTS

The following discussion will refer to various modules, components or circuits. Such modules, components or circuits may generally comprise hardware, software instructions stored on a computer (or processor) readable medium, or a combination thereof. Accordingly, the scope of various aspects of the present invention should not be limited by characteristics of particular hardware and/or software implementations of a module, component or circuit unless explicitly claimed. For example and without limitation, various aspects of the present invention may be implemented by one or more processors (e.g., a microprocessor, digital signal processor, baseband processor, microcontroller, etc.) executing software instructions (e.g., stored in volatile and/or non-volatile memory). Also for example, various aspects of the present invention may be implemented by application-specific electrical circuitry (e.g., an application-specific integrated circuit (“ASIC”)).

The following discussion may also refer to communication networks (e.g., including access points, servers and/or databases) and various aspects thereof. For the following discussion, a communication network is generally the communication infrastructure through which a device with communication capability (e.g., a portable communication device) may communicate with other devices. For example and without limitation, a communication network may comprise a cellular telecommunication network, a wireless metropolitan area network (WMAN), a wireless local area network (WLAN), a wireless personal area network (WPAN), etc. A particular communication network may, for example, generally have a corresponding communication protocol according to which a device may communicate with the communication network. Unless so claimed, the scope of various aspects of the present invention should not be limited by characteristics of a particular type of communication network.

Additionally, the following discussion will generally refer to a personal electronic book system. A non-limiting example of such a personal electronic book system includes a portable electronic device specifically adapted for presenting an electronic book to a user in human-perceivable form. Such a personal e-book system may, for example, have a primary purpose of providing electronic book information to a user, but may also include non-e-book-related capabilities. Other non-limiting examples may include: a personal computing device (e.g., a handheld computer, portable digital assistant, smart-phone, portable multimedia player, laptop computer, etc.) operating as an electronic book device (e.g., executing an electronic book application). Note that a personal electronic book system may, for example, output electronic book information to a user in various human-perceivable forms (e.g., as text output on a video display, as audio output through a speaker, as tactile sensory output, etc.).

Various aspects of the present invention may, for example, comprise system module(s) (or component) or method steps for providing audio command (e.g., voice command) control over operation of a personal electronic book system. Various aspects of the present invention may also, for example, comprise system module(s) or method steps for defining such audio command control (e.g., customized to a particular electronic book system or user thereof).

Various aspects of the present invention will now be exemplified in a non-limiting manner by a set of figures and discussion thereof. It should be noted that the following figures and associated discussion are merely exemplary and should by no means limit the scope of various aspects of the present invention unless explicitly claimed.

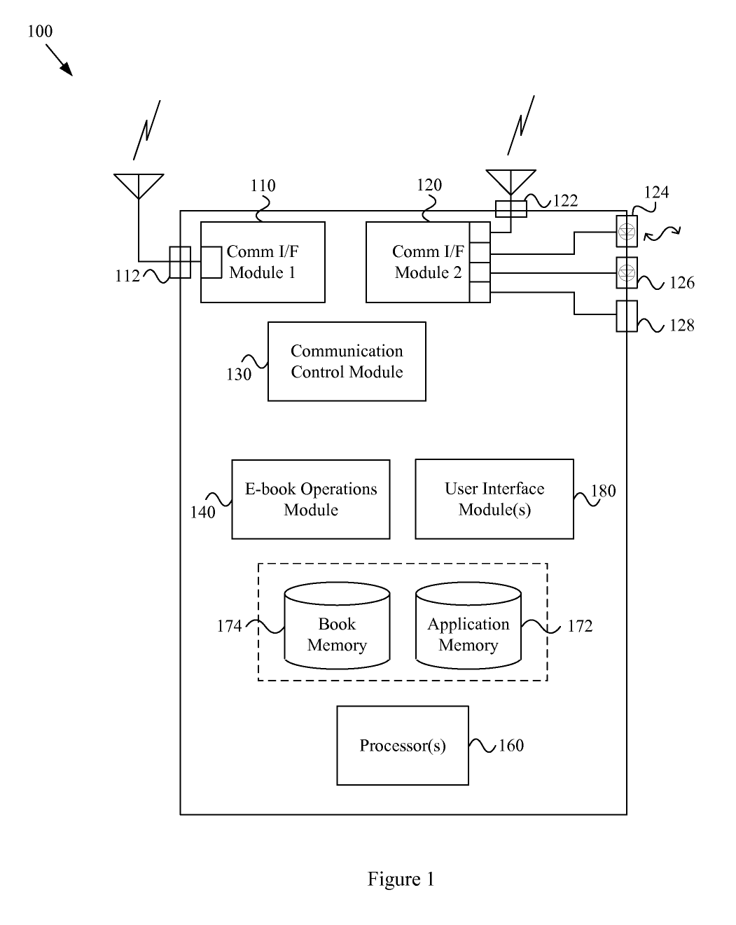

Turning first to FIG. 1, such figure is a block diagram of a non-limiting exemplary personal electronic book system 100, in accordance with various aspects of the present invention. The personal electronic book system 100 may, for example and without limitation, comprise characteristics of a portable electronic device specifically adapted for presenting an electronic book to a user in human-perceivable form. Such a personal e-book system may, for example, have a primary purpose of providing electronic book information to a user, but may also include non-e-book-related capabilities. Other various non-limiting examples were provided previously.

The personal electronic book system 100 may, for example, comprise one or more Communication Interface Module(s) 110, 120 that operate to manage communication with devices or other entities external to the system 100. For example, as will be discussed in more detail below, various aspects of the present invention may comprise interacting with databases, networked servers, personal computers, other personal electronic book systems, network access points, and any of a variety of other networked devices through one or more communication networks. The Communication Interface Module(s) 110, 120 may, for example, operate to manage such communication (e.g., in accordance with any or a variety of communication protocols). The Communication Interface Module(s) 110, 120 may, for example, operate to manage communication with a telecommunication network, general data network, cable network, WLAN, WPAN, WMAN, wired television and/or television network, satellite communication network, etc. The Communication Interface Modules 110, 120 may also, for example, operate to communicate directly with other devices (e.g., other personal electronic book systems, servers, etc.).

The illustrated exemplary First Communication Interface Module 110 operates to communicate through a wireless RF port 112. The illustrated exemplary Second Communication Interface Module 120 operates to communicate through a plurality of ports (e.g., a wireless RF communication port 122, a non-tethered optical communication port 124, a tethered optical communication port 126, and a wired communication port 128.

The personal electronic book system 100 may, for example, comprise a Communication Control Module 130. Such a Module 130 may, for example, coordinate and/or manage communication through the Communication Interface Modules 110, 120. In an exemplary implementation, the Communication Interface Modules 110, 120 may perform activities related to respective lower protocol levels (e.g., PHY layer, data link layer, network layer, etc.) while the Communication Control Module 130 performs activities related to higher layer protocol levels (e.g., transport layer, session layer, presentation layer, etc.). In such an implementation, the Communication Control Module 130 may implement common higher level layers, while the Communication Interface Modules 110, 120 implement respective different lower level layers.

The personal electronic book system 100 may, for example, comprise one or more User Interface Module(s) 180. Such User Interface Module(s) 180 may, for example, operate to output information to a user of the system 100. For example, the User Interface Module(s) 180 may operate to generate video output signals that cause a video display of the system 100 (or coupled system) to output electronic book text information to a user. Also for example, the User Interface Module(s) 180 may operate to generate audio output signals that cause a speaker of the system 100 (or coupled system) to output electronic book audio information to a user. Further for example, the User Interface Module(s) 180 may operate to generate tactile output signals and/or electrical signals adapted to convey electronic book information via electrical stimulation of the nervous system.

Additionally for example, the User Interface Module(s) 180 may operate to output user interface information to a user (e.g., graphical user interface information) in any of the above-mentioned manners. The User Interface Module(s) 180 may generally operate to output any of a variety of types of information to a user, non-limiting examples were provided above, and additional non-limiting examples will be provided below.

The User Interface Module(s) 180 may also, for example, operate to receive input information from a user of the system 100. For example and without limitation, the User Interface Module(s) 180 may operate to receive audio input information (e.g., voice command information) from a user of the system 100. Also for example, the User Interface Module(s) 180 may operate to receive tactile input information from a user of the system 100 (e.g., keypad input, touch screen input, mouse input, etc.). Additionally for example, the User Interface Module(s) 180 may operate to receive video input information from a user of the system 100 (e.g., through native or coupled video input devices), including still image input information and/or moving picture input information. As will be explained in more detail below, various aspects of the present invention may utilize such input information (e.g., audio input information) to control operation of the personal electronic book system 100.

The User Interface Module(s) 180 may, for example, operate to receive audio input commands through a microphone that is on-board (or native to) the system 100 or communicatively coupled to the system 100 (e.g., through one of the Communication Interface Modules 110, 120). Such audio input commands may, for example, comprise commands to navigate around an electronic book currently being presented to the user. For example, such audio input commands may comprise commands related to paging (e.g., page up, page down, go to page #, etc.). Also for example, such audio input commands may comprise commands related to traversing an electronic book by paragraph (e.g., previous paragraph, next paragraph, go to paragraph #, etc.). Additionally for example, such audio input commands may comprise commands related to traversing an electronic book by chapter (e.g., next chapter, previous chapter, go to chapter #, etc.). Further for example, such audio input commands may comprise commands related to traversing an electronic book by section (e.g., go to index, bibliography, table of contents, column, subject, article, author, topic, etc.).

The audio input commands may, for example comprise selections from an index, table of contents, bibliography, etc. Such audio input commands may, for example, comprise commands related to traversing an electronic book by scrolling (e.g., scroll up, scroll down, etc.). Additionally for example, such audio input commands may be related to traversing an electronic book by line (e.g., line up, line down, N lines up, M lines down, go to line #, etc.). Also for example, such audio input commands may comprise commands related to specifying text characteristics (e.g., font, size, style, etc.). The audio input commands may, for example, comprise any of a variety of audio commands related to traversing an electronic book.

The audio input commands may, for example, comprise commands related to control of general electronic book visual presentation characteristics. For example, the audio input commands may comprise audio commands to start and/or stop presentation of an electronic book. Additionally for example, the audio input commands may comprise audio commands to control magnification of an electronic book being displayed (e.g., increase magnification, decrease magnification, etc.). Also for example, the audio input commands may comprise audio commands to control video display characteristics (e.g., brightness, contrast, color, screen saver timer, screen saver type, etc.).

The audio input commands may, for example, comprise commands related to general electronic book audio presentation characteristics. For example, the audio input commands may comprise audio commands to control audio output volume, pitch/frequency, language, dialect, presentation speed, male/female voice characteristics, etc.

Additionally for example, the audio input commands may comprise commands related to electronic book searching. For example, the audio input commands may comprise commands to search within a book currently being presented to a user (e.g., searching for words, phrases, etc.). Also for example, the audio input commands may comprise commands to search within a library of books (e.g., a locally stored library, networked library available at a server, network of a plurality of libraries, etc.). Additionally, for example, the audio input commands may comprise commands to search all known electronic books and libraries thereof. Such audio search commands may, for example, comprise commands specifying searching for key words, phrases, topics, meta tags, authors, price or price range, free books, cheapest books, organization, media company, publisher, etc.

Also for example, the audio input search commands may, for example, comprise words or phrases to be converted to text for searching. Additionally, such audio input search commands may comprise audio words or phrases, where the desired search is to be performed on audio characteristics of such audio words or phrases (e.g., audio signal patterns). Such searching may, for example, be particularly useful in searching an audio book or collection of audio books.

Further for example, the audio input search commands may comprise words corresponding to logical operators to specify complex searches with a plurality of search constraints. For example, the User Interface Module(s) 180 may operate to (e.g., via key word or acoustical pattern recognition) parse out logical operators from an audio phrase to form a logical search equation.

The audio input commands may, for example, be related to controlling various aspects of communication between the personal electronic book system and other devices (e.g., other personal electronic book systems, communication network access points, electronic book servers, user I/O devices, personal computers, local routers, etc.). As discussed above, the personal electronic book system 100 may comprise one or more Communication Interface Modules 110, 120 that operate to communicate with a plurality of different types of communication networks. The User Interface Module(s) 180 may, for example, operate to receive audio input commands to control various aspects of such communication.

For example and without limitation, such audio input commands may comprise commands to specify a particular network (or type of network) and/or server with which to communicate. Also for example, such audio input commands may comprise commands to specify a computer and/or other personal electronic book system with which to communicate (e.g., directly and/or peer-to-peer via a communication network). Further for example, such audio input commands may comprise commands including secure access information. Additionally for example, such audio input commands may comprise commands to specify respective preferences or priorities for particular communication networks and/or remote electronic book systems.

The audio input commands may also, for example, be related to adding notes to an electronic book. For example, such audio input commands may comprise audio notes to attach to an electronic book or to a particular location in an electronic book. Such audio notes may, for example, be for attachment as audio files and/or for conversion to text for attachment as textual information (e.g., within an electronic book file or one or mores associated therewith). Such audio input commands may also, for example, comprise commands to add video notes (e.g., static and/or dynamic image notes) to an electronic book or a particular location of section thereof. Such audio input commands may further, for example, comprise audio commands to define a relationship between an electronic book (or section or location therein) and another document (e.g., locally stored, network accessible, etc.).

The audio input commands may additionally, for example, be related to bookmarking an electronic book. Such bookmarking may, for example, be a general bookmark or may, for example, be associated with a particular user of the personal electronic book system.

The audio input commands may, for example, be related to editing an electronic book. For example, such audio input commands may comprise commands from the user to insert text, overwrite text, copy/paste text, etc. A user may thus make corrections or other personal enhancements to an electronic book. Such modifications may, for example, be made in an e-book file or maintained in one or more files associated with the e-book file.

The audio input commands may, for example, be related to the acquisition of, or access to, an electronic book. For example, such audio input commands may comprise specifying an electronic book to acquire and/or obtain access to. Also for example, such audio input commands may comprise purchase information (e.g., account information, membership information, credit/debit card information, etc.). Also for example, such audio input commands may comprise information specifying manner of electronic book delivery (e.g., complete download, streaming portions as needed, etc.).

The audio input commands may, for example, be related to the configuration of the personal electronic book system. For example, such audio input commands may comprise commands to update system software, configure hardware, configure the user interface, etc. For example, such audio input commands may comprise commands that specify information utilized to establish communication with various communication networks, electronic book servers, other personal electronic book systems, etc.

The personal electronic book system 100 may, for example, comprise an E-book Operations Module 140 that generally operates to control e-book-related operation of the system 100. Such operations may, for example and without limitation, include operations corresponding to any or all of the audio commands discussed previously. For example, upon receiving a user input related to electronic book functionality (e.g., an audio user input), the E-book Operations Module 140 may determine, based at least in part on the received user input, a manner in which to operate the personal electronic book system, and then operate the personal electronic book system 100 in accordance with the determined manner of operation. Non-limiting examples of such operation will now be presented.

As discussed above, the User Interface Module(s) 180 may operate to receive any of a variety of audio input commands. Various aspects of the present invention comprise system module(s) (or components) and/or methods to define and/or customize such audio user input operation.

The personal electronic book system 100 may, for example, be associated with a set of user input commands (e.g., audio input commands). Such set of user input commands may be a default set of user input commands or may be customized to the system 100 or a user thereof.

In a mode of operation (e.g., in response to a user command to operate in such mode), the E-book Operations Module 140 may operate to interact with a user (e.g., via the User Interface Module(s) 180) to define the set of user input commands (e.g., audio user input commands).

The E-book Operations Module 140 may, for example, operate to maintain a table correlating e-book related commands and/or sequences thereof with respective audio inputs. Initially, for example, such commands may be associated with respective default audio input commands. Such default audio input commands may, for example, be based on normative audio signal (e.g., voice) characteristics. Since, however, audio input signal characteristics will vary from user to user, the E-book Operations Module 140 may operate to provide for customization of such audio input signal characteristics. Such customization may, for example, provide for improved audio input operation with respect to a default set of electronic book commands and may also provide for the definition of new custom commands (or macros).

Regarding audio input signal customization for existing commands, the E-book Operations Module 140 may, for example, maintain a list of commands (or macros) and respective associated audio input commands. The E-book Operations Module 140 may, for example, utilize the User Interface Module(s) 180 to provide a mechanism by which a user may associate audio inputs from the user with known electronic book commands. As a non-limiting example, a user may select a known electronic book command and provide an audio input (e.g., the user's voice) to be associated with the known command. The E-Book Operations Module 140 may then, for example, process the audio input and associate such audio input with the known command. The E-Book Operations Module 140 may, for example, operate to record such audio input verbatim and associate the recorded audio input with the known command. Alternatively for example, the E-Book Operations Module 140 may operate to analyze the audio input to identify distinctive audio characteristics (e.g., spectral content, inflections, temporal characteristics, etc.) of the audio input and associate such distinctive audio characteristics with the known command. Note that such process may comprise receiving a plurality of examples of such audio input and processing such examples to identify common distinctive audio characteristics between the examples and associate such identified common distinctive audio characteristics with the known command. As another example, the E-Book Operations Module 140 may operate to receive a plurality of alternative audio inputs to associate with a single known command. Then, for example, a plurality of distinctly different audio inputs may result in a same known command (e.g., “Up” and “Back” may in various contexts result in execution of the same electronic book control function).

As mentioned above, the E-Book Operations Module 140 may also provide for the definition of new custom commands (or macros). For example, a user may indicate (e.g., through the User Interface Module(s) 180) that the user desires to define a new command. The E-Book Operations Module 140 may then utilize the User Interface Module(s) 180 to interact with the user to specify the new command. Such a new command may, for example, be a sequence of commands (or macro) that the user commonly utilizes. Once such new command or command sequence is specified, the E-Book Operations Module 140 may then utilize the User Interface Module(s) 180 to communicate with the user to define one or more audio user input(s) to associate with the new command.

As mentioned previously, the E-Book Operations Module 140 may, for example, define a set of audio input commands for the personal electronic book system 100 or may, for example, define respective sets of audio input commands for each of a plurality of users of the system 100. In a scenario where the system 100 has a plurality of users, defining respective sets of audio input commands for each of the plurality of users advantageously provides for audio input operation tailored to respective voices of the plurality of users.

The E-Book Operations Module 140 may, for example, store command definition information locally (e.g., in memory of the system 100) or may store command definition information in a networked memory (e.g., of a remote system) accessible to the system 100 (e.g., utilizing the Communication Interface Modules 110, 120). In an exemplary scenario in which such command definition information is stored in a memory (e.g., of a remote system) accessible to the system 100 through a network, any personal electronic book system may access such information to configure operation of such system to a particular user. Additionally, such operation provides a mechanism by which a user of a subsequent generation of personal electronic book system may conveniently transfer audio command information. Note that defining a set of audio commands for a user may involve the E-Book Operations Module 140 communicating associated information to and from a remote system in which audio command definition information is stored.

As discussed above, the E-Book Operations Module 140 may operate to manage the receipt and/or definition of user input commands (e.g., audio input commands). The E-Book Operations Module 140 may also operate to process received user input commands and operate the personal electronic book system 100 in accordance with such commands. Various non-limiting examples of such commands were provided above. The following discussion will include examples of operating the system 100 in accordance with such commands.

For example, in an exemplary scenario where a user inputs audio input commands to control presentation of an electronic book that is currently being presented to the user, the E-Book Operations Module 140 may operate the system 100 to present the electronic book in accordance with such commands. For example, the E-Book Operations Module 140 may interact with the Book Memory 174 or networked source of e-book information (e.g., via the communication modules 110, 120, 130) to retrieve e-book information desired by the user, process such information, and then interact with the User Interface Module(s) 180 to effect the desired presentation of e-book information to the user.

Also for example, in an exemplary scenario where a user inputs audio commands to control video display output and/or audio output characteristics of the system 100, the E-Book Operations Module 140 may operate the system 100 in a manner reflective of such audio commands. For example, the E-Book Operations Module 140 may interact with the User Interface Module(s) 180 to adjust video and/or audio output characteristics.

Additionally for example, in an exemplary scenario where a user inputs audio commands to control the manner in which the system 100 interfaces with networks and/or other systems external to the personal electronic book system 100, the E-Book Operations Module 140 may operate the system in a manner reflective of such audio commands. For example, the E-Book Operations Module 140 may interact with the Communication Interface Module(s) 110, 120 and/or the Communication Control Module 130 to configure communication of the system 100 in the user-specified manner.

Further for example, in an exemplary scenario where a user inputs audio commands to perform searching, the E-Book Operations Module 140 may operate to manage such searching. As discussed previously, such searching may comprise searching an electronic book currently being presented to the user or may comprise searching a library of local e-books stored in memory (e.g., Book Memory 174). Such searching may also, for example, comprise searching one or more networked libraries (or collections) of electronic books. In such case, the E-Book Operations Module 140 may operate to manage utilization of the Communication Modules 110, 120, 130 to communicate with such networked libraries and to perform the desired search.

Also for example, in an exemplary scenario where a user inputs audio commands to acquire an electronic book, the E-Book Operations Module 140 may operate to manage such acquisition. As discussed previously, such searching may comprise utilizing the Communication Modules 110, 120, 130 to interact with an electronic book server to perform a purchase and/or download of the desired electronic book. Such searching may also, for example, comprise searching one or more networked libraries (or collections) of electronic books. The E-Book Operations Module 140 may then, for example, store an acquired electronic book in the Book Memory 174.

Additionally, for example, in an exemplary scenario where a user inputs audio commands to edit and/or add notes to an electronic book, the E-Book Operations Module 140 may operate to manage such editing and/or annotation. For example, the E-Book Operations Module 140 may operate to modify electronic book information stored in the Book Memory 174, create a back-up copy of the original book, etc. Also for example, the E-Book Operations Module 140 may interface with the User Interface Module(s) 180 to acquire the editing and/or annotation information from the user.

Still further for example, in an exemplary scenario where a user inputs audio commands to update the personal electronic book system 100 (e.g., requesting software updates), the E-Book Operations Module 140 may operate to manage such updating. Such operation may, for example, comprise utilizing the Communication Modules 110, 120, 130 to communicate with a software/firmware server via one or more communication networks. Such operation may also, for example, comprise utilizing the User Interface Module(s) 180 to interact with the user during such updating.

The previously presented examples were presented as a non-limiting set of examples to clarify various aspects of the present invention. Aspects of such examples should in no way limit the scope of various aspects of the present invention unless specifically claimed.

As mentioned previously, the personal electronic book system 100 comprises a Book Memory 174. The Book Memory 174 may either be a stand-alone memory or may be a portion of a shared memory device. The Book Memory 174 may, for example, comprise volatile and/or non-volatile memory. As a non-limiting example, the Book Memory 174 may comprise non-volatile memory for long-term electronic book storage and may also comprise volatile memory that is utilized to store electronic book data during presentation of the electronic book.

The personal electronic book system 100 may also comprise an Application Memory 172. Any or all of the functionality discussed previously may be implemented in dedicated hardware, but may also be implemented by a processor (e.g., an onboard processor 160) executing software instructions. Such software instructions may, for example, be stored in Application Memory 172. Though the Application Memory 172 and Book Memory 174 are illustrated as separate memories, such memories 172, 174 may be implemented in a common memory device or in separate memory devices.

The personal electronic book system 100 may also comprise at least one processor 160. Such processor may, for example, include a general purpose processor, a microcontroller, a digital signal processor, an application-specific processor, etc. As mentioned above, any or all of the functionality discussed previously may be implemented by such a processor executing software instructions.

The personal electronic book system 100 illustrated in FIG. 1 was presented by showing various functional modules. Such a modular illustration was chosen for illustrative clarity. The scope of various aspects of the present invention, however, should not be limited by characteristics of such illustration unless explicitly claimed. For example, various modules may be implemented in hardware (dedicated or shared) and/or software. Accordingly, the scope of various aspects of the present invention should not be limited by various details regarding specific hardware and/or software implementations unless explicitly claimed. Also for example, various modules may, for example, share various hardware and software components. For example, a plurality of such modules may be implemented by a same processor implementing software instructions stored in a same memory, and a portion of such software instructions may be shared between various functional modules. Accordingly, the scope of various aspects should not be limited by arbitrary notions of separation and/or commonality between various modules unless explicitly claimed.

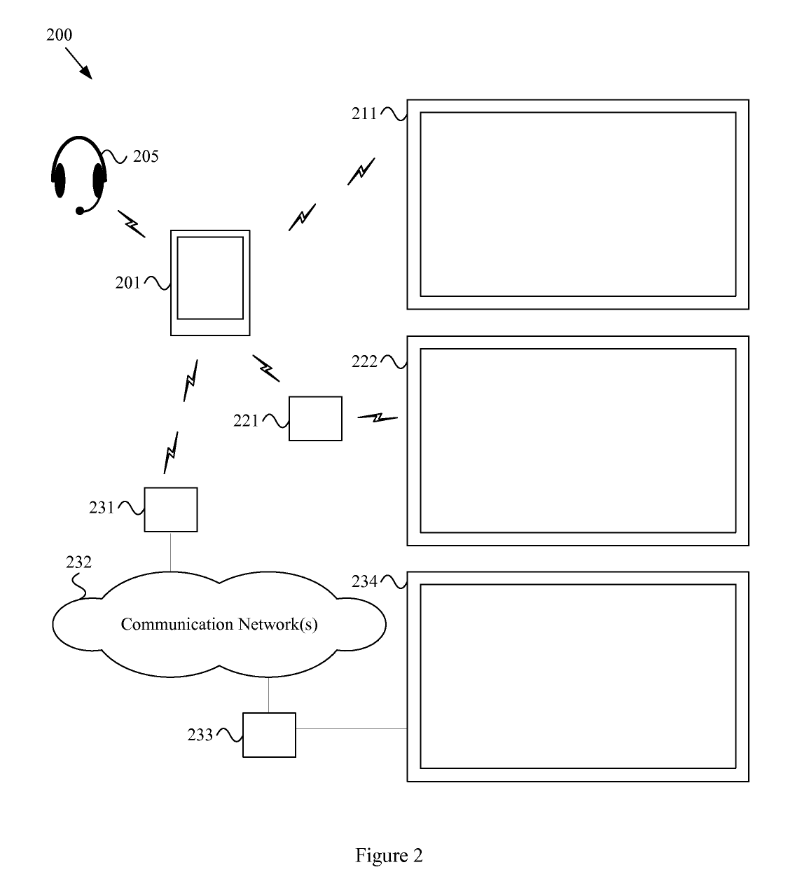

Turning next to FIG. 2, such figure provides an illustration of a personal electronic book operating environment 200, in accordance with various aspects of the present invention.

The exemplary operating environment 200 includes a personal electronic book system 201. Such system 201 may, for example and without limitation, share any or all characteristics with the exemplary personal electronic book system 100 illustrated in FIG. 1 and discussed previously.

The personal electronic book system 201 is illustrated communicatively coupled through a wireless RF interface to a portable headset 205 (or earpiece). As discussed above with regard to FIG. 1, the personal electronic book system 201 may comprise a communication interface module that operates to establish wireless communication with any of a variety of communication networks (e.g., telecommunication network, WMAN, WLAN, WPAN, etc.). For example and without limitation, such a personal electronic book system 201 may comprise a communication interface module that operates to establish and/or maintain a wireless communication link to a wireless headset 205, wireless earpiece, wireless microphone, etc. Such communication may, for example, be conducted utilizing a relatively short-range wireless communication protocol (e.g., Bluetooth and/or IEEE 802.11). A user of the system 201 may, for example, utilize a microphone of the wireless headset 205 to communicate audio input commands to the personal electronic book system 201. Also, a user of the system 201 may, for example, utilize the headset 205 to present audio information (e.g., user interface audio, electronic book audio, music, etc.) to the user.

As discussed previously in the discussion of the personal electronic book system 100 of FIG. 1, the User Interface Module(s) 180 may operate to provide a visual output of an electronic book (or user interface therefor) on a native (on-board) display of the system 100. The User Interface Module(s) 180 may also, for example, communicate video information to display devices external to the system 100 (e.g., utilizing a Communication Interface Module 110, 120). Referring to FIG. 2, the personal electronic book system 201 may, for example, communicate (e.g., wired or wirelessly) information directly to an external video display device 211. Such an external video display device 211 may, for example, comprise a television system, a personal computer system and display, etc.

The personal electronic book system 201 may also, for example, communicate video electronic book information or user interface information to an external video display device 222 via a local router 221 (e.g., a home wired and/or wireless data router). The personal electronic book system 201 may further, for example, communicate such video information to an external video display device 234 via a first communication network access point 231, communication network 232, and second communication network access point 233. The communication network 232 may comprise characteristics of any of a variety of the communication network types discussed previously, including without limitation, the Internet, telecommunication network, satellite and/or terrestrial communication network, LAN, MAN, etc.

The previous discussion of FIG. 2 focused primarily on the communication of video information to video display devices. Note, however, that the communication of electronic book audio information is generally analogous (e.g., communicating audio information to an external audio presentation device (e.g., audio receiver, autonomous speakers, headset, etc.) directly, via a local router, via a plurality of access points and a communication network, etc.

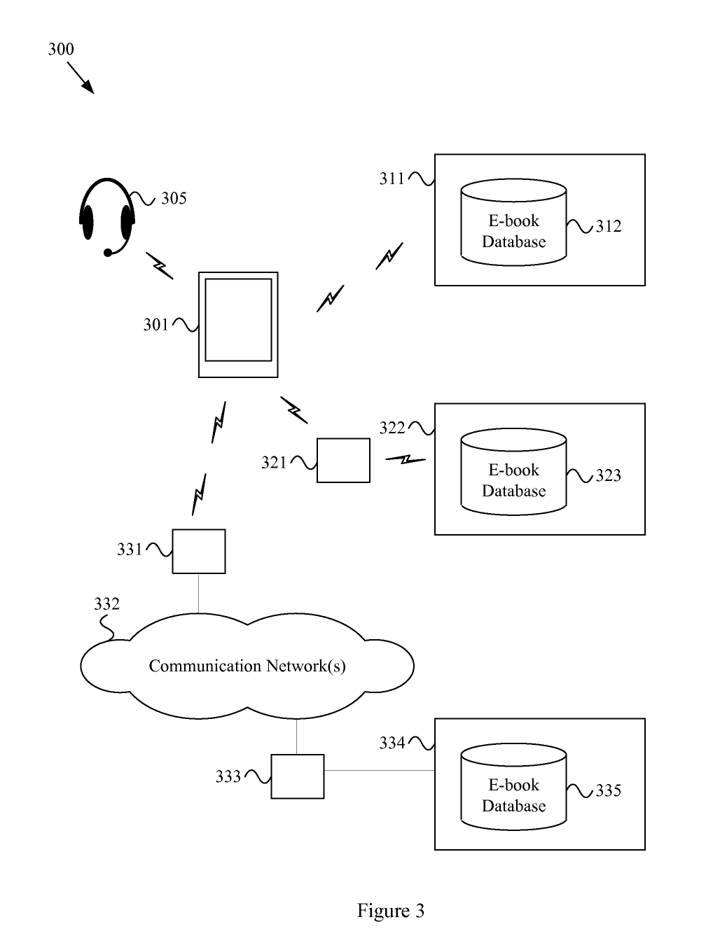

Turning next to FIG. 3, such figure provides an illustration of a personal electronic book operating environment 300, in accordance with various aspects of the present invention.

The exemplary operating environment 300 includes a personal electronic book system 301. Such system 301 may, for example and without limitation, share any or all characteristics with the exemplary personal electronic book systems 100, 201 illustrated in FIGS. 1-2 and discussed previously.

The personal electronic book system 301 is illustrated communicatively coupled through a wireless RF interface to a portable headset 305 (or earpiece). As discuss above with regard to FIG. 1, the personal electronic book system 201 may comprise a communication interface module that operates to establish wireless communication with any of a variety of communication networks (e.g., telecommunication, WMAN, WLAN, WPAN, etc.). For example and without limitation, such a personal electronic book system 301 may comprise a communication interface module that operates to establish and/or maintain a wireless communication link to a wireless headset 305, wireless earpiece, wireless microphone, etc. Such communication may, for example, be conducted utilizing a relatively short-range wireless communication protocol (e.g., Bluetooth and/or IEEE 802.11). A user of the system 301 may, for example, utilize a microphone of the wireless headset 305 to communicate audio input commands to the personal electronic book system 301. Also, a user of the system 301 may, for example, utilize the headset 305 to present audio information (e.g., user interface audio, electronic book audio, music, etc.) to the user.

As discussed previously in the discussion of the personal electronic book system 100 of FIG. 1, the User Interface Module(s) 180 may operate to provide a user interface by which a user of the system 100 may (e.g., inputting audio commands from headset 305) direct the system 100 to search remote libraries (or collections) of electronic books and/or acquire electronic books from remote sources. In response to such commands, the E-book Operations Module 140 may utilize one or more Communication Modules 110, 120, 130 to communicate with external networks and systems to perform such a search and/or acquisition.

Referring to FIG. 3, the personal electronic book system 301 may, for example, communicate (e.g., wired or wirelessly) information directly with an external system 311 having an e-book database 312. Such an external system 311 may, for example, comprise a personal computer system, a bookstore kiosk book server, a public library server, etc.

The personal electronic book system 301 may also, for example, communicate electronic book search and/or acquisition information with an external system 322 having an E-book Database 323 via a local router 321 (e.g., a home wired and/or wireless data router). The personal electronic book system 301 may further, for example, communicate such information with an external system 334 having an E-book Database 335 via a first communication network access point 331, communication network 332, and second communication network access point 333. The communication network 332 may comprise characteristics of any of a variety of the communication network types discussed previously, including without limitation, the Internet, telecommunication network, satellite and/or terrestrial communication network, LAN, MAN, etc.

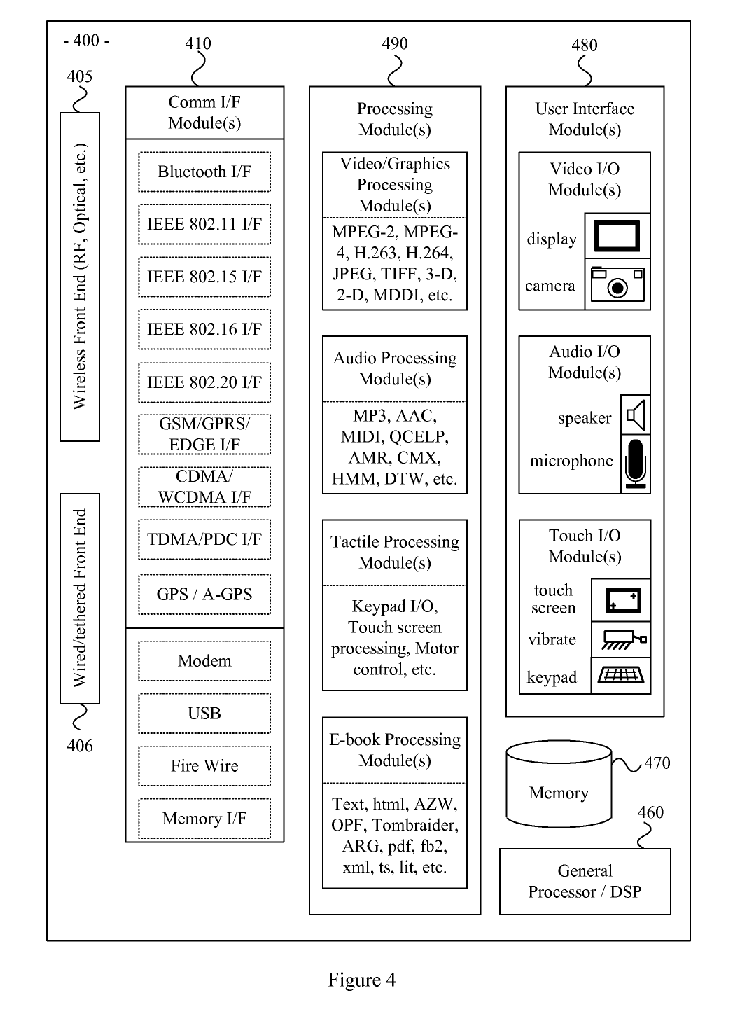

Turning next to FIG. 4, such figure presents another non-limiting exemplary personal electronic book system 400, in accordance with various aspects of the present invention. The illustrated mobile computing device 400 may share any or all aspects with the exemplary mobile computing devices 100, 201, 301 illustrated in FIGS. 1-3 and discussed previously. For example, the mobile computing device 400 (or various modules thereof) may operate to perform any or all aspects of the exemplary functionality discussed previously with regard to FIGS. 1-3). For example, the illustrated mobile computing device 400 provides various non-limiting examples of various general modules discussed previously with regard to FIG. 1.

For example, the personal electronic book system 400 comprises a processor 460. Such a processor 460 may, for example, share any or all characteristics with the processor 160 discussed with regard to FIG. 1. Also for example, the mobile computing device 400 comprises a memory 470. Such memory 470 may, for example, share any or all characteristics with the Book Memory 174 and/or Application Memory 172 discussed with regard to FIG. 1.

Also for example, the personal electronic book system 400 may comprise any of a variety of User Interface Module(s) 480. Such User Interface Module(s) 480 may, for example, share any or all characteristics with the User Interface Module(s) 180 discussed previously with regard to FIG. 1. For example and without limitation, the User Interface Module(s) 480 may comprise: a display device, a camera (for still or moving picture acquisition), a speaker, an earphone (e.g., wired or wireless), a microphone, a video screen (e.g., a touch screen), a vibrating mechanism, a keypad, and/or any of a variety of other user interface devices (e.g., a mouse, a trackball, a touch pad, light pen, game controlling device, etc.).

The exemplary personal electronic book system 400 may also, for example, comprise any of a variety of communication modules (405, 406, and 410). Such communication module(s) may, for example, share any or all characteristics with the Communication Interface Module(s) 110, 120 and Communication Control Module 130 discussed previously with regard to FIG. 1. For example and without limitation, the Communication Interface Module(s) 410 may comprise: a Bluetooth interface module; an IEEE 802.11, 802.15, 802.16 and/or 802.20 module; Any of a variety of cellular telecommunication interface modules (e.g., GSM/GPRS/EDGE, CDMA/CDMA2000/1x-EV-DO, WCDMA/HSDPA/HSUPA, TDMA/PDC, WiMAX, etc.); any of a variety of position-related communication interface modules (e.g., GPS, APGS, etc.); any of a variety of wired/tethered communication interface modules (e.g., USB, FireWire, RS-232, wireline and/or cable modem, etc.); any of a variety of communication interface modules related to communicating with external memory devices; etc. The exemplary personal electronic book system 400 is also illustrated as comprising various wired 406 and/or wireless 405 front-end modules that may, for example, be included in the communication interface modules and/or utilized thereby.

The exemplary personal electronic book system 400 may also comprise any of a variety of Processing Module(s) 490. Such Processing Module(s) 490 may, for example, be utilized to assist in processing various types of information discussed previously (e.g., with regard to video processing, image processing, audio processing, general user interface information data processing, etc.). For example and without limitation, the Processing Module(s) 490 may comprise: Video/graphics Processing Modules (e.g. MPEG-2, MPEG-4, H.263, H.264, JPEG, TIFF, 3-D, 2-D, MDDI, etc.); general audio and/or speech recognition Processing Modules (e.g., MP3, AAC, MIDI, QCELP, AMR, CMX, Hidden Markov model (HMM), Dynamic time warping (DTW), etc.); Tactile Processing Modules (e.g., Keypad I/O, touch screen processing, motor control, etc.); and/or E-book Processing Modules (e.g., text, html, AZW, OPF, Tombraider, ARG, pdf, fg2, xm., ts, lit, etc.).

The previous discussion provided various non-limiting examples of system architecture and/or environments and discussed various functions performed by the systems and/or modules or components thereof. The following discussion will present various functional aspects of the present invention in a flow diagram form.

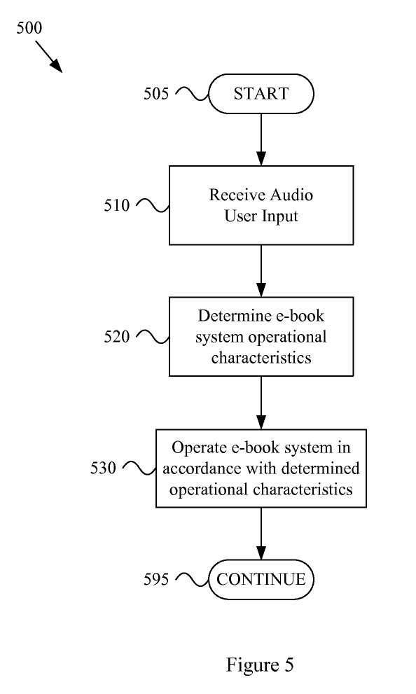

Turning to FIG. 5, such figure is a flow diagram illustrating a non-limiting exemplary method 500 for operating a personal electronic book system, in accordance with various aspects of the present invention. The exemplary method 500 may, for example, share any or all functional characteristics with the personal electronic book systems 100, 201, 301, 400 discussed previously with regard to FIGS. 1-4.

The exemplary method 500 begins execution at step 505. The method 500 may begin execution in response to any of a variety of causes and/or conditions. For example and without limitation, the method 500 may begin executing in response to a signal (e.g., from the user or another system) to begin. Such a signal may, for example, be generated in response to a tactile user input, an audio user input, etc.

The exemplary method 500 may, at step 510, comprise receiving a user input (e.g., an audio user input). Various exemplary aspects associated with receiving an audio user input were presented previously in the discussion of FIGS. 1-4. Accordingly, step 510 may share any or all functional aspects discussed previously with regard to receiving a user input. For example and without limitation, step 510 may share any or all of such aspects discussed with regard to the User Interface Module(s) 180, Communication Modules 110, 120, 130 and/or E-book Operations Module 140. As discussed above in more detail, such user input may be received in a variety of manners, including through user interface features (e.g., a microphone) on-board the personal electronic book system, through user interface features external to the personal electronic book system and communicatively coupled thereto, etc. Many non-limiting examples of such commands (e.g., audio input commands related to modify a view of an electronic book, control video display and/or audio output characteristics, searching commands, communication control commands, electronic book acquisition commands, editing commands, bookmarking commands, annotation commands, etc.) were discussed previously.

The exemplary method 500 may, at step 520, comprise determining (e.g., based at least in part on an audio user input received at step 510) a manner in which to operate the personal electronic book system. Various exemplary aspects associated with determining such a manner of operation were presented previously in the discussion of FIGS. 1-4. Accordingly, step 520 may share any or all functional aspects discussed previously with regard to determining a manner in which to operate a personal electronic book system. For example and without limitation, step 520 may share any or all of such functional aspects discussed with regard to the E-book Operations Module 140. As discussed above, the personal electronic book system is operated in accordance with commands provided by the user (e.g., audio input commands), and in the exemplary systems discussed previously, such operation may generally be determined and/or managed by the E-book Operations Module 140.

For example, step 520 may comprise analyzing an audio input command received at step 510 to determine actions to take in performing such command. Such determination may, for example, comprise considering current operating mode of the personal electronic book system in determining a course of action. For example, a received audio input command may cause the performance of different actions depending on the manner in which the electronic book system is presently operating (e.g., whether an electronic book is currently being presented, whether a user has been identified, what type of electronic book is currently being presented, which user is currently utilizing the personal electronic book system, whether one or more communication networks or particular communication networks are presently available, etc.).

As discussed previously, the performance of various commands may correspond to communicating with various systems external to the personal electronic book system. Step 520 may comprise determining the manner in which to communicate with such systems, including for example, determining how to utilize various communication interface modules of the personal electronic book system.

Also as discussed previously, the performance of various commands may correspond to searching a current electronic book or a collection of electronic books. In such exemplary scenarios, step 520 may comprise determining the manner in which to perform such searching (e.g., searching locally stored electronic books, searching networked libraries or collections, searching book store servers, forming and communicating database queries, etc.).

Further as discussed previously, the performance of various commands may correspond to configuring communication capabilities of the personal electronic book system. In such exemplary scenarios, step 520 may comprise analyzing a received user command (e.g., a received user audio command) to determine how to perform such communication configuration.

Additionally as discussed previously, the performance of various commands may correspond to editing and/or annotating an electronic book. In such exemplary scenarios, step 520 may comprise determining how to perform such editing and/or annotating. For example and without limitation, different electronic book formats may have different requirements for performing such operations.

Still further, as discussed previously, the performance of various commands may correspond to setting or adjusting operational characteristics of various user interface features (e.g., user input features, video display features, audio output features, etc.). In such an exemplary scenario, step 520 may comprise determining now to operate various components of the personal electronic book system to accomplish the directives of the received command.

In general, step 520 comprises determining (e.g., based at least in part on an audio user input received at step 510) a manner in which to operate the personal electronic book system. The previously-provided examples are merely exemplary, and the scope of various aspects of the present invention should not be limited by aspects of such examples, unless such aspects are explicitly claimed.

The exemplary method 500 may, at step 530, comprise operated the personal electronic book system in accordance with the determined manner of operation (e.g., as determined at step 520). Various exemplary aspects associated with such operating were presented previously in the discussion of FIGS. 1-4. Accordingly, step 530 may share any or all functional aspects discussed previously with regard to operating a personal electronic book system. For example and without limitation, step 530 may share any or all of such functional aspects discussed with regard to the E-book Operations Module 140. As discussed above, the personal electronic book system is operating in accordance with commands provided by the user (e.g., audio input commands), and in the exemplary systems discussed previously, such operation may generally be determined and/or managed by the E-book Operations Module 140.

For example, as discussed previously, such operating may comprise operating the personal electronic book system's user interface modules, communication modules, memory modules, processing modules, etc. In general, step 530 comprises operating the personal electronic book system in accordance with the determined manner of operation (e.g., as determined at step 520). The previously-provided examples of such operating are merely exemplary, and the scope of various aspects of the present invention should not be limited by aspects of such examples, unless such aspects are explicitly claimed.

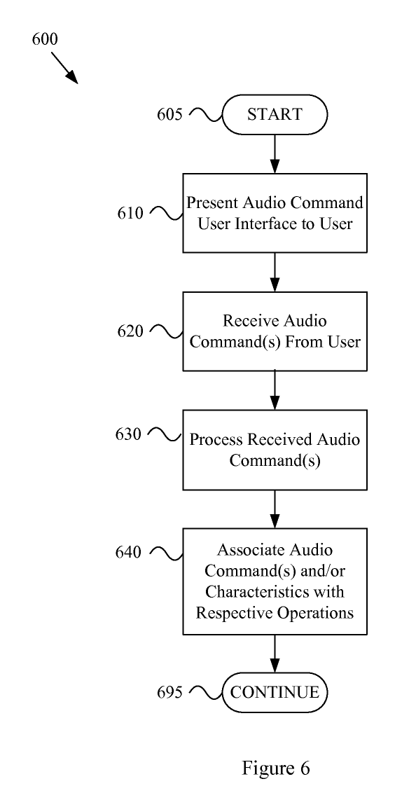

The exemplary method 500 may, at step 595, comprise performing continued operation. Such continued operation may comprise performing any of a variety of additional functions. For example and without limitation, step 595 may comprise returning execution flow to step 510 for receiving and responding to additional user input commands (e.g., user audio inputs). Also for example, step 595 may (e.g., in various exemplary scenarios involving command set definition) comprise beginning execution of the method 600 of FIG. 6.

In general, the exemplary method 500 shows a non-limiting example of a method for operating a personal electronic book system, in accordance with various aspects of the present invention. Accordingly, the scope of various aspects of the present invention should not be limited by particular characteristics of the exemplary method 500 unless explicitly claimed.

Turning to FIG. 6, such figure is a flow diagram illustrating a non-limiting exemplary method 600 for operating a personal electronic book system, in accordance with various aspects of the present invention. The exemplary method 600 may, for example, share any or all functional characteristics with the personal electronic book systems 100, 201, 301, 400 discussed previously with regard to FIGS. 1-4.

The exemplary method 600 begins execution at step 605. The method 600 may begin execution in response to any of a variety of causes and/or conditions. For example and without limitation, the method 600 may begin executing in response to a signal (e.g., from the user or another system) to begin. Such a signal may, for example, be generated in response to a tactile user input, an audio user input, etc. The method 600 may, for example, begin execution in response to a user command (e.g., a user audio input) to define audio input commands.

The exemplary method 600 may, at step 610, comprise presenting an audio command user interface to a user. As discussed previously, the E-book Operations Module 140 may work with the User Interface Module(s) 180 to interact with a user.

Step 610 may, for example, comprise presenting a graphical user interface, an audio user interface, textual user interface, etc. For example, step 610 may comprise presenting a user interface to a user to assist the user in defining audio commands for the personal electronic book system. Such a user interface may, for example, provide a mechanism by which a user may select existing operational control commands for the electronic book system and provide corresponding audio input commands for such existing commands. Also, for example, such a user interface may, for example, provide a mechanism by which a user may define new operational control commands (or sequences of commands), the execution of which may be triggered by an input audio command.

Step 610 may, for example, comprise outputting a user interface to a user that is tailored to the particular user. For example, such interface may present and/or receive audio command information that is specific to the particular user. Accordingly, step 610 may comprise determining the identity of the user (e.g., via system login, voice recognition, etc.) to determine characteristics of the user interface. In such a scenario, a plurality of users may define respective sets of audio commands with which to control operation of the personal electronic book system, each of which may be stored locally on-board the system and/or at a remote system accessible via a communication network.

Step 620 may, for example, comprise receiving one or more audio commands from a user. Step 620 may, for example and without limitation, share any or all functional characteristics with the exemplary E-book Operations Module 140, User Interface Module(s) 180 and/or Communication Modules 110, 120, 130 discussed previously.

As explained previously with regard to the exemplary personal electronic book system 100, a user may associate a single audio command with a control command or sequence of control commands. Also for example, a user may associate a plurality of alternative audio commands with an operational control command or sequence thereof. Further for example, a user may input a plurality of example audio commands corresponding to an operational control command or sequence thereof (e.g., so such plurality of example commands may be processed together).

Also as explained previously, such audio commands may be input to the personal electronic book system directly through an on-board microphone or, for example, via a microphone that is communicatively coupled to the personal electronic book system (e.g., via a wirelessly coupled headset or earpiece).

In general, step 620 may comprise receiving one or more audio commands from a user. Accordingly, the scope of various aspects of the present invention should not be limited by any particular manner of receiving such audio commands unless explicitly claimed.

Step 630 may, for example, comprise processing one or more audio commands received from a user (e.g., at step 620). Step 630 may, for example and without limitation, share any or all functional characteristics with the exemplary E-book Operations Module 140, discussed previously.

As explained previously with regard to the exemplary personal electronic book system 100, a user may associate a single audio command with an operational control command or sequence of control commands. In such a scenario, step 630 may comprise processing the single audio command to identify various audio signal characteristics thereof. Such characteristics may, for example, be subsequently utilized to identify a matching audio command received during normal operation of the personal electronic book system. Step 630 may alternatively, for example, comprise processing an input audio command for storage and subsequent comparison to an audio command input during normal operation.

Also for example, a user may associate a plurality of alternative audio commands with an operational control command or sequence thereof. In such a scenario, step 630 may comprise processing the plurality of alternative audio commands to identify various respective audio signal characteristics thereof. Such characteristics may, for example, be subsequently utilized to identify a matching audio command received during normal operation of the personal electronic book system. Step 630 may alternatively, for example, comprise processing a plurality of alternative input audio commands for storage and subsequent comparison to an audio command input during normal operation.

Further for example, a user may input a plurality of example audio commands corresponding to an operational control command or sequence thereof (e.g., so such plurality of example commands may be processed together). In such a scenario, step 630 may comprise processing the plurality of example audio commands to identify various common audio signal characteristics thereof. Such common characteristics may, for example, be subsequently utilized to identify a matching audio command received during normal operation of the personal electronic book system. Step 630 may alternatively, for example, comprise processing all of the example audio commands for storage and subsequent comparison to an audio command input during normal operation.

In general, step 630 may comprise processing one or more audio commands received from a user (e.g., at step 620). Accordingly, the scope of various aspects of the present invention should not be limited by any particular manner of processing such audio commands unless explicitly claimed.

Step 640 may, for example, comprise associating one or more received and/or processed audio commands (e.g., received at step 620 and/or processed at step 630) with an electronic book operational command or sequence thereof. Step 640 may, for example and without limitation, share any or all functional characteristics with the exemplary E-book Operations Module 140, discussed previously.

As explained previously with regard to the exemplary personal electronic book system 100, a user may associate a single audio command with an operational control command or sequence thereof. In such a scenario, step 640 may comprise associating the single audio command (e.g., as received at step 620 and/or as processed at step 630) with such a control command or sequence thereof. For example, a recorded version of an input example audio command may be associated with an electronic book system operational control command or sequence thereof. Also for example, particular identified audio signal characteristics of an input example audio command may be associated with an electronic book system operational control command or sequence thereof. In such a scenario, an audio command input during normal operation of the personal electronic book system may be matched to a control command or sequence thereof.

Also for example, a user may associate a plurality of alternative audio commands with an operational control command or sequence thereof. In such a scenario, step 640 may comprise associating the plurality of alternative audio commands (e.g., as received at step 620 and/or as processed at step 630) with such a control command or sequence thereof. For example, a recorded version of each alternative input example audio command may be associated with an electronic book system operational control command or sequence thereof. Also for example, particular identified audio signal characteristics of each respective alternative input example audio command may be associated with an electronic book system operational control command or sequence thereof. In such a scenario, an audio command input during normal operation of the personal electronic book system may be matched to a control command or sequence thereof.

Further for example, a user may input a plurality of example audio commands corresponding to an operational control command or sequence thereof (e.g., so such plurality of sample commands may be processed together). In such a scenario, step 640 may comprise associating the plurality of example audio commands (e.g., as received at step 620 and/or as processed at step 630) with such a control command or sequence thereof. For example, a recorded version of each example input example audio command may be associated with an electronic book system control operation or sequence thereof. Also for example, as discussed with regard to step 630, the plurality of example audio commands may be processed to identify various common audio signal characteristics thereof. In such a scenario, step 640 may comprise associating the identified common audio signal characteristics with an electronic book system operational control command or sequence thereof.

Note that step 640 may also, for example, comprise associating particular audio commands with particular users. For example, a first user may define an audio command for a particular operation, and a second user may define a different audio command for the same particular operation. In such a manner of operation, for example, since different users may have different voice characteristics, the audio command user interface for an electronic book system may be customized to each particular user thereof. Additionally, as discussed previously, the personal electronic book system may also include a set of default audio commands that are intended to be generally universal between different users.

The exemplary method 600 may, at step 695, comprise performing continued operation. Such continued operation may comprise performing any of a variety of additional functions. For example and without limitation, step 695 may comprise returning execution flow to step 610 for additional audio command definition. Also for example, upon completion of the exemplary method 600, execution flow may return to step 505 of the method 500 illustrated in FIG. 5.

In general, the exemplary method 600 shows a non-limiting example of a method for operating a personal electronic book system, in accordance with various aspects of the present invention. Accordingly, the scope of various aspects of the present invention should not be limited by particular characteristics of the exemplary method 600 unless explicitly claimed.

In summary, various aspects of the present invention provide a system and method in an electronic book for providing audio-controlled (e.g., voice-controlled) operation thereof. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A personal electronic book system comprising:
at least one module operable to, at least:
receive an audio user input;
determine, based at least in part on the received audio user input, a manner in which to operate the personal electronic book system; and
operate the personal electronic book system in accordance with the determined manner of operation.

2. The system of claim 1, wherein the at least one module is operable to interface with a user to define a set of audio commands for controlling the personal electronic book system.

3. The system of claim 2, wherein the at least one module is operable to interface with a user to define a set of audio commands by, at least in part, operating to receive and process an exemplary audio input corresponding to a respective electronic book system control command.

4. The system of claim 3, wherein the at least one module is operable to associate the exemplary audio input with a respective electronic book system control command and a particular user

5. The system of claim 2, wherein the at least one module is operable to interface with a user to define a set of audio commands by, at least in part, operating to receive and process a plurality of exemplary audio inputs corresponding to a single electronic book system control command.

6. The system of claim 2, wherein the at least one module is operable to interface with a user to define a set of audio commands by, at least in part, operating to:
receive a plurality of exemplary audio inputs corresponding to a single electronic book system control command;
process the received plurality of exemplary audio inputs to identify common acoustical characteristics of the plurality of exemplary audio inputs; and
associate the identified common acoustical characteristics with the single electronic book system control command.

7. The system of claim 2, wherein the at least one module is operable to interface with a user to define a set of audio commands by, at least in part, operating to:
receive an exemplary audio input;
receive user input identifying a sequence of electronic book system control commands; and
associate the exemplary audio input with the sequence of electronic book system control commands.

8. The system of claim 2, wherein the at least one module is operable to communicate information describing at least a portion of the defined set of audio commands to a remote system via a communication network.

9. The system of claim 2, wherein the at least one module is operable to interface with a remote system via a communication network to define the set of audio commands.

10. The system of claim 1, wherein the at least one module is operable to:
identify a user of the system based, at least in part, on the audio user input; and
output a user interface corresponding to the identified user.

11. The system of claim 10, wherein the at least one module is operable to store a plurality of respective sets of audio commands corresponding to a plurality of respective users.

12. The system claim 1, wherein the at least one module operates the personal electronic book system in accordance with the determined manner of operation by, at least in part, operating to communicate a signal through a communication network to an electronic book server.

13. The system of claim 1, where the audio user input comprises a navigational command to navigate through an electronic book presently being displayed.

14. The system of claim 1, where the audio user input comprises a search command, and in response to the received search command, the at least one module operates the personal electronic book system in a search mode.

15. The system of claim 14, wherein the at least one module operates the personal electronic book system in a search mode by, at least in part, operating to provide an audio user interface by which the user may search an electronic book currently being presented by the personal electronic book system.

16. The system of claim 14, wherein the at least one module operates the personal electronic book system in a search mode by, at least in part, operating to provide an audio user interface by which the user may search one or more local libraries of electronic books, said one or more local libraries stored locally by the personal electronic book system.

17. The system of claim 14, wherein the at least one module comprises a communication network interface and operates the personal electronic book system in a search mode by, at least in part, operating to provide an audio user interface by which the user may search one or more networked libraries of electronic books.

18. The system of claim 1, wherein the at least one module is operable to conduct wireless communications with electronic book servers via a plurality of different types of wireless communication networks, and where the at least one module is operable to select, based at least in part on the received audio user input, one of the plurality of different types of wireless communication networks for communication with an electronic book server.

19. The system of claim 18, where the plurality of different types of wireless communication networks comprises a wireless cellular telecommunication network and a wireless local area network (WLAN).

20. The system of claim 1, wherein the at least one module is operable to, in response to the received audio input, communicate wirelessly peer-to-peer with another personal electronic book system.

21. The system of claim 20, wherein the at least one module is operable to, in response to the received audio input, communicate wirelessly directly with another personal electronic book system.

22. A method for operating a personal electronic book system, the method comprising:
receiving an audio user input;
determining, based at least in part on the received audio user input, a manner in which to operate the personal electronic book system; and
operating the personal electronic book system in accordance with the determined manner of operation.

23. The method of claim 22, comprising interfacing with a user to define a set of audio commands for controlling the personal electronic book system.

24. The method of claim 23, wherein interfacing with a user to define a set of audio commands comprises receiving and processing an exemplary audio input corresponding to a respective electronic book system control command.

25. The method of claim 22, comprising:
identifying a user of the system based, at least in part, on the audio user input; and
outputting a user interface corresponding to the identified user.

26. The method of claim 22, wherein operating the personal electronic book system in accordance with the determined manner of operation comprises communicating a signal through a communication network to an electronic book server.

27. The method of claim 22, where the audio user input comprises a navigational command to navigate through an electronic book presently being displayed.

28. The method of claim 22, where the audio user input comprises a search command, and operating the personal electronic book system in accordance with the determined manner of operation comprises operating the personal electronic book system in a search mode.

29. The method of claim 22, comprising selecting, based at least in part on the received audio user input, one of a plurality of different types of wireless communication networks for communication with an electronic book server.

30. The method of claim 22, comprising in response to the received audio input, communicating wirelessly peer-to-peer with another personal electronic book system.
